(19) United States
(12) Patent Application Publication
(10) Pub. No.: US 2015/0169800 A1
(43) Pub. Date: Jun. 18, 2015

(54) METHOD FOR LOCATING THE SOURCE OF GAS FLOWS IN A GEOGRAPHICAL AREA, INVOLVING A SELECTION OF MEASUREMENTS

(71) Applicant: Commissariat à Iénergie atomique et aux énergies alternatives, Paris (FR)

(72) Inventor: Thomas Lauvaux, Taintrux (FR)

(21) Appl. No.: 14/413,090

(22) PCT Filed: Aug. 2, 2013
(86) PCT No.: PCT/EP2013/066259

§ 371 Date: Jan. 6, 2015

(30) Foreign Application Priority Data
Aug. 6, 2012 (FR) 12 57639

(51) Int. Cl. G06F 17/50; G06F 17/10

(52) U.S. Cl. CPC G06F 17/5009; G06F 17/10

(57) ABSTRACT

The invention is based on a particular selection of observations which is applied to a model consisting of a direct model and a reverse model to deduce production and absorption streams of gas such as greenhouse effect gases in a geographical area by measuring concentrations thereof at stations (3) and by simulating displacements thereof from production or absorption places (1, 2). This selection consists in assessing the concentrations by exploiting both models, making the difference of these assessments and comparing them with thresholds which advantageously depend on assessed errors or uncertainties in the models.

The present invention relates to a method for locating origins and assessing gas flows in a geographical area, involving a selection of measurements. It can find use in particular in detecting greenhouse effect gas production in order to be able to ascribe their origin to a determined agent as a function of the emission place. The streams are herein appearance amounts of the gas detected, or possibly disappearance amounts, which can be experienced for example in areas covered with carbon dioxide absorbing vegetation; the streams associated with these areas are then negative.

The method is first carried out by observations, that is, measurements of concentrations of the gas in different places located either in the geographical area the stream of which is attempted to be mapped, or in the vicinity of this geographical area. Models are also available, enabling displacements of the gas to be simulated from the origin places of the streams to the detection places of the concentrations, by considering many parameters including instantaneous weather characteristics, from which wind speed and direction can in particular be recited. Direct models are available enabling concentrations to be calculated using a priori assessed streams, and so-called reverse or adjoined models enabling the streams to be assessed using the measured concentrations. The observations are periodically made and the streams are normally also assessed during long periods of time, or even constantly, because they are likely to vary continuously.

The physical phenomena undergone by an atmosphere are particularly complex and their modelling is difficult, even accepting errors or uncertainties in modelling the physical phenomena and in the measurements. Working with two different models the results of which can be compared is often required to notice temporary occurrences of unacceptable errors in the results, noticed when the latter are too discordant. The modelling defects are indeed different for the direct and reverse models, which are generally of different natures (for example, respectively Eulerian and Lagrangian, or Eulerian and its linearized adjoint) and the geographical area discretization griddings of which are also different.

Some conditions should be met to achieve a realistic simulation of the atmospheric dynamics. One of the main use conditions relies on the atmosphere stability. The stability conditions correspond to the fluid dynamics regimens. When the stability conditions (or regimens) are stable or neutral, the dimension of the physical processes is too small to be properly reproduced by the models. Only so-called convective or instable conditions offer the possibility to properly simulate the observed dynamics. Stable or neutral periods of time are often characterized by dynamic structures with a size lower than the model resolution. Even though some sub-grid parameterizations exist, they can only allow to approximate the reality observed. But, a reversal system will use accurate information about the atmospheric dynamics next to the surface, then almost systematically erroneous.

Under these stable or neutral conditions, where the stream is laminar with very low vertical wind speeds, the simulated height of the atmospheric boundary layer is also almost systemically erroneous as well as the vertical mixing speed, which causes a bias (systematic error) of the calculations made by the models, with the observations of the measurements of the concentrations, made at a particular altitude, that cannot be correlated anymore to the actual concentration in that place, with the atmosphere composition that must be taken into account at all the altitudes. And at some times, the vertical mixing can be modelled differently by the direct model and the reverse model.

In practice, the great sensitivity of the models to the modelling errors under stable, neutral conditions, and even under more favourable instable conditions, generates a great variability in the results between both models, in terms of amplitude as well as signs (positive and negative biases). Both models, adjoined and direct ones, intended to reproduce results equivalent from slightly different physical schemes, then produce substantially different results, without physical consistency in most cases. The comparison of the results of both models (adjoined and direct) then enables these observation periods of time to be removed under different atmospheric stability regimens not to bias the reverse streams. It is preferable, or even necessary, that the observations of the greenhouse gas concentrations be simply removed during these periods of time. Without this, the assessed streams would be affected by systematic errors causing an overestimation or an underestimation in the order of 10 to 20% on the yearly scale.

In some existing methods, only the observations taken in a diurnal period of time are taken into account to feed the models. This criterion relies on the hypothesis that the solar radiation necessarily causes instable conditions. It is however tedious to take into account the variable times of the sunrise and sunset according to the seasons, and that is why, in most methods, the procedure is simpler and the reversal systems only use part of the observations, by defining the favourable period of time as a fixed time slot. An example can be found in the article by the present inventor (T. Lauvaux) “Constraining the CO₂ budget of the corn belt: exploring uncertainties from the assumptions in a mesoscale inverse system” Atmos. Chem. Phys. Discuss. 11, 20855-20888 doi: 10.5194 (acpd-11-20855-2011), 2011, where an error threshold associated with the adjoined model is defined in nocturnal times at a value such that almost all the external observations are discarded. Four main elements are an issue with such a slot.

Firstly, if the slot is limited by the sunrise and sunset times of the winter sun in any seasons, it is much reduced. If, on the contrary, it is selected on a period of daytime which extends beyond the diurnal times in winter, it brings about the use of nocturnal, and thus suspect, observations during winter.

Secondly, the stability conditions also depend on the horizontal wind speed, which generates a vertical mixing through shearing. So, we observe, apart from sunshine times during daytime and even in nocturnal period of time, situations where stability conditions are favourable, and the measured concentrations are thus exploitable to properly simulate the atmospheric dynamics. With a fixed time slot, the concentrations simulated during these periods of time are not used, which generates a loss of information. And conversely, stable conditions can occur in a diurnal period of time, in particular in some cold weathers.

Thirdly, if switching from unstable to stable conditions (for example in the evening) is shown by an abrupt stop of the vertical mixing, thus readily observable, switching from stable to unstable conditions is more gradual (on the morning for example). The setting up of the atmospheric boundary layer which corresponds to the atmosphere portion affected by a strong vertical mixing is slow and gradual. It is thus difficult to set with accuracy a fixed boundary between so-called convective times (unstable conditions) and so-called stable times, in particular during these transition phases, and this for all the days of the year.

Generally, the assumption that a given atmospheric stability regimen is favourable or not to the success of simulation reminds poorly defined and only corresponds to an incomplete definition of the problem.

The distinction between diurnal and nocturnal periods of time thus does not enable the existence of stable or unstable conditions of the atmosphere to be defined with accuracy. Other criteria can also be used to detect these stable periods of time, such as stability criteria (Richardson number, friction velocity, etc.). However, the relationship between the stability conditions and the simulation errors of the atmospheric dynamics is not accurately set. The models can in some cases produce inconsistent results before entering into a stable or neutral condition (or after exiting therefrom).

It can be seen that this criterion of exclusion from some periods of time is insufficient both because the correlation between the stable or instable conditions of the atmosphere and the insufficiencies of the models is not perfect, and because the correlation between these atmosphere conditions and the periods of time of daytime is not perfect either.

Finally, identifying a favourable period does not indicate whether the model is efficient and fulfils the reversal hypotheses. The adjoined model can fail under unstable conditions, or, on the contrary, properly simulate the gas transport under stable conditions.

The present method for detecting streams by a reversal of observations is original in that there is a step of preselecting the observations which relies on a better criterion than that just discussed.

The invention allows a better protection of so-called optimized obtained streams in opposition to a priori streams generally used in these methods, from systematic errors of the transport model.

In a general form, the invention relates to a method of cartographic detection of streams of at least one gas in a geographical area, the streams being gas appearance or disappearance amounts, comprising the steps of:

periodic measurements of concentrations of the gas in the geographical area or close to said geographical area, at measurement times;

periodic measurements of weather characteristics, including speeds and directions of winds, in an investigation period of time comprising the measurement times, at least in the geographical area;

application of numerical models to relate the streams to the concentrations, in particular by simulating displacements of the gas during the investigation period of time, and by exploiting the measurements of the weather characteristics and other parameters comprising time; the numerical models comprising a direct model giving concentrations as a function of assessed streams and a reverse model giving streams as a function of measured or assessed concentrations;

the method comprising exclusions of some of the measurements of concentrations under conditions where the models are regarded as inaccurate,

characterized in that the method comprises two assessments of concentrations by using the direct model and the reverse model, and in that the exclusions are decided for moments when a difference between both assessments is higher than a threshold.

Most of the value of the invention comes from the threshold being advantageously calculated as a function of uncertainties or errors on the model, being generally time varying, and that it therefore enables a greater safety to discard some observations.

The invention will now be described in connection with the figures:

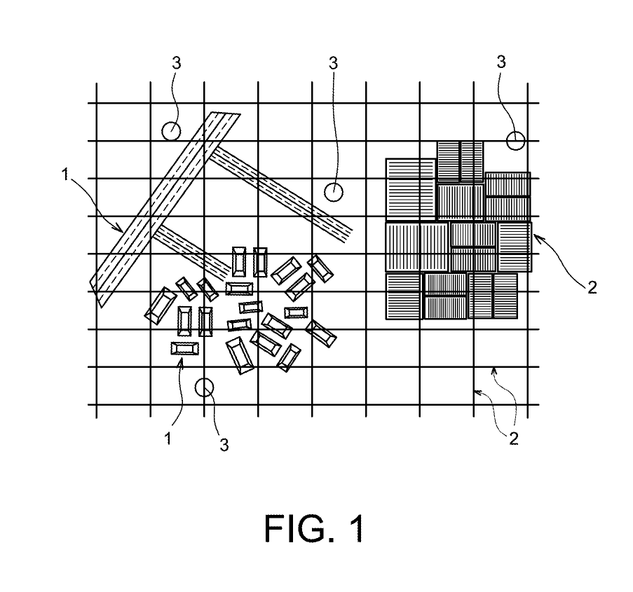

FIG. 1 is a view of an environment of measurements;

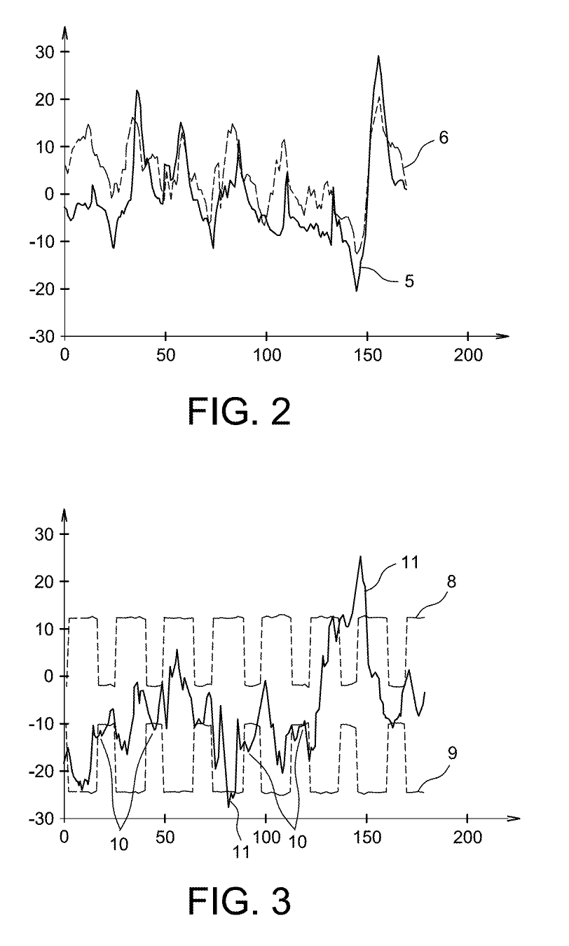

FIG. 2 is a graph for comparing concentrations of a gas;

FIG. 3 illustrates the implementation of the invention.

The reversal methods of the kind of the invention produce optimized streams as well as their errors in the kilometric scale, by using observations of concentrations of greenhouse effect gases and so-called a priori greenhouse effect gas streams. These a priori streams are specialized and at sub-daily time steps, and can come from a model or an assessment based on inventories, observations, or even come from another reversal system. The a priori streams are in practice assessment distributed in area of the gas amounts, most often greenhouse effect ones, emitted from the surface, or absorbed, in the case of a vegetation covered surface for example. The observations are volume or mass amounts of a greenhouse effect gas measured in atmosphere. In practice, they are expressed in different unities, whether in molar ratio, volume ratio or mass ratio. These observations are thus mixing ratios of the gas considered (CO₂, CH₄, N₂O, CO, . . . ) and air surrounding it. These observations of concentrations are measured by virtue of calibrated instruments provided on measurement towers, in air vehicles, watercraft, or land vehicles, or even remotely for measurements of the atmospheric column.

The method uses finally a priori streams, and atmospheric concentrations for the observations. The boundary conditions which can be added as a further unknown in the reversal system will not be described herein. These boundary conditions described the concentrations of greenhouse effect gases in proximity of the simulation domain. They are not part of the main product of the system (the optimized streams), but are considered as an additional unknown required to be characterized.

Both amounts, a priori or calculated streams and observed concentrations, represent different physical measurements. It is thus necessary to be able to translate the information from one amount to the other, and conversely. To do this, the system uses a model which enables both these amounts to be related. As the streams emitted at the surface are transported by the atmosphere up to the measurement points, the models used herein are atmospheric models which enable the transport between the time and the place where any molecule of the gas is emitted and its measurement point in the atmosphere to be simulated. These atmospheric transport models simulate internal and external variables describing the dynamics and physics of the atmosphere at hourly and sub-hourly time scales. At kilometre scales as well as greater scales, these atmospheric models include many numerical schemes which enable dynamics to be simulated, and are generally called meso-scale at kilometre scales, or general circulation models at greater scales. Finally, the method uses mathematical algorithms to assess the optimal solution from the a priori information (surface stream and boundary conditions). These methods are known as regularization, assimilation, reversal, or even optimization methods.

The only applicability criterion of the present method relies on using an adjoined or reverse model. Some methods, such as overall methods, can disregard the adjoined model using only the direct model to optimize streams. Apart from them, any method which relies on using an adjoined model, either the simplified or modified direct model, or a different model used as a direct transport adjoint, can benefit from the present invention. From the suitable adjoined models, will be recited so-called particular Lagrangian models, and Eulerian models which correspond to a linearization of the direct model, either generated by an automated method as the use of the linear tangent, or from a very laborious “handmade” construction.

Furthermore, the method is generally statistic, which means that the quantization of errors or uncertainties is also or even greater than the absolute values of the results. The use of observations which would be incompatible with the prescribed errors would be detrimental both on the results in absolute value and on the a posteriori assessed errors, which would be overestimated or underestimated. One purpose of the invention is thus not only to better assess the absolute values of the streams, but also the errors likely to be made in assessing these absolute values.

The different components of the numerical reversal required to obtain the streams from the measured concentrations are thus characterized by their associated errors. These errors which affect the a priori streams as well as the observations of the concentrations of greenhouse effect gases are processed by the optimization algorithm. Their role is dual in that they enable the accuracy to be quantified on the optimized streams (detected by the method), as well as the values of these optimized streams. In other words, a poorly quantified error at the input of the system affects the quantization of the optimized streams and their associated errors. These errors are in practice represented by a variance which affects each stream value or each observation used in the system, as well as spatial and time correlations which translate the relationships between these variances. The term used is error covariance of the a priori streams and observations. A particular hypothesis on which the errors rely is that the observation errors are not biased. In other words, the average of the observation errors is null. This condition, if it is not fulfilled, generates a systematic introduction of errors from the observations in the optimized streams. In particular, the transport modelling errors, which are part of the observation errors, make up the greatest source of systematic errors in the reversal systems. Any bias in the atmospheric model can then induce erroneous values of optimized streams, as well as an over- or under-evaluation of the errors of the optimized streams.

Referring to FIG. 1, a geographical area can be seen where streams of a determined gas can appear and which comprises in particular places 1 where these streams appear in a favoured manner, possibly places 2 where they are absorbed, and observation stations 3, which measure the gas concentrations of the stream and the weather parameters useful for modelling, first the wind speed and direction, as well as temperature, pressure, etc. The stations 3 can be placed in the geometrical area itself where the streams appear or are absorbed, and also next to this area. A gridding 4 covers the entire geographical area considered and splits it into plots for the purposes of modelling. The griddings can be and by the way are generally different for both models, wherein the gridding of the reverse model can be sub-kilometric whereas that of the direct model is generally wider.

The invention is based on a comparison between two assessments of concentrations coming from the application of the direct and reverse models. The concentrations are generated through an atmospheric transport model capable of transporting finite amounts of a given gas (tracer) in the dynamic fields. The gas is represented by an amount released at each time step and in each area point, which amount is injected at the surface. This mass is diluted in the atmospheric air column discretised into vertical levels from a few meters to a few tens of meters in general. The gas typically represents a stream with anthropic or biological origin calculated from data or simulated through a vegetation model for example. In the case of emissions related to the use of fossil energies, the streams come from the combination of energy consumption data converted into greenhouse effect gas amount via coefficients. These coefficients called emission factors are statistic measures which represent the average amount of greenhouse effect gas emitted as a function of the fuel amount used and the method involved. For example, the emissions from the circulation combine measurements of road streams and emission factors representing the different types of vehicles and their energy efficiency. The adjoined model, normally used to assess the streams, is here applied in the reverse direction, which is possible and even simple because it is generally of a linear nature. The direct model and the reverse model thus operate concurrently giving results of the same category, and which would be identical if the models were perfect. By using the same initial data (the streams) for both models, the only cause of the difference in their results then comes from the transport errors, and thus the models themselves, which is the case when comparing the concentrations of the direct model with those of the reverse model.

The results obtained are of the kind of that of FIG. 2 and comprise an atmospheric concentration curve of a greenhouse effect gas from the direct model H (called direct curve) 5 and an atmospheric concentration curve of the same gas from the reverse model H_{adj} (called adjoined curve) 6 at the same times of an investigation period of time which is expressed herein in hours, the concentrations being expressed in parts per million in the atmosphere. These concentrations vary quite strongly and more or less cyclically with time, and there are some differences sometimes significant between both curves (the presence of negative concentrations is explained by the subtraction of a uniform value corresponding to a natural average concentration, and these negative concentrations are thus observed in particular when the vegetation absorbs carbon dioxide by photosynthesis). The WRF (Weather Research Forecast) model on a 10 km resolution gridding was used as the direct model. The adjoined model was a so-called Lagrangian particle dispersion model LPDM described in 1995 and which uses different amounts and parameters simulated by the direct WRF model such as atmospheric pressure, temperature, wind, etc.

It can be assumed that the calculations made by the models give reliable results when both evaluations of the concentrations are concordant, even if exceptions (generally low in number) can exist when systematic errors in the same direction are made in both models; but the periods of time having a good concordance are not very numerous in the measurements of FIG. 1, and it is difficult to well define a discordance threshold beyond which the exclusion of observations will be decided, since the significant differences are acceptable when the streams are also significant.

It is thus advantageous to base the observation selection criterion on a threshold or a digital filter which depends on the uncertainties or errors of the method.

An error ε can be calculated from an a priori error of the stream to be assessed and an error from the observations noted B and R_{dir}, in the case of the direct model H. These errors B and R_{dir} are matrix ones. The error can be expressed as

ε={square root over (variance(E(i))+covariance(E(i)))}

where E=HBH^{T}+R_{dir} at each time step i in projection on the mathematical area of the concentrations.

The error of B can be assessed from sensitivity tests if the streams come from a model. The sensitivity of the model is tested at the parameters for example, and the error is thus calculated. Direct observations of the streams can also be used. In this case, the stream model used to provide the a priori streams is compared. This method can however be troublesome since the direct measurements of the streams represent very small areas, lower than one kilometre. For the observation errors R, they comprise several error sources, but are almost systematically dominated by the modelling errors of the transport. The sensitivity investigations of the transport model can thus be carried out, with overall simulations. Weather data can also be used, but this remains more delicate because this error matrix R is defined in the concentration area. If an error on wind is obtained for example, there is no simple means to convert it into error on the concentrations.

Therefore, the calculation of the difference between both assessments such as those which are provided by the curves 5 and 6, and which difference can be expressed by the difference H.x−H_{adj}^{T}.x in the case where the streams x are provided in known amounts (a priori streams) of a tracer gas, is carried out, and where the concentrations assessed by the a priori streams by means of the direct model are equal to H.x.

FIG. 3 will now be commented. Curve 7 corresponds to the difference between both assessments of the concentrations, the threshold is set to ±(\sqrt{HBH^{T}+R_{dir}}) with amplitude strongly varying according to the diurnal and nocturnal periods of time. The positive and negative thresholds are represented by the curves 8 and 9 of FIG. 3.

The observations corresponding to the time when the curve 7 is in the interval defined by the thresholds 8 and 9 are accepted, and the others are excluded. The most remarkable exclusion periods of time have been referenced 10 in FIG. 3. As could be expected, most of them are in nocturnal periods of time, where the curves 8 and 9 are narrowed, but many observations made during this nocturnal period of time are however considered as acceptable, whereas some observations made during the diurnal periods and referenced 11 are not.

Consequently, the invention is a significant improvement with respect to the conventional criteria for selecting observations. It will be implemented, in practice, in a computer system consisting of a computer or a computing network wherein the numerical models used for assessing the gas flows will also be implanted.

What is claimed is:

1-6. (canceled)

7. A method for locating origins of streams of at least one gas in a geographical area, the streams being gas appearance or disappearance amounts, comprising the steps of:
periodic measurements of concentrations of the gas in the geographical area or close to said geographical area, at measurement times;
periodic measurements of weather characteristics, including speeds and directions of winds, in an investigation period of time comprising the measurement times, at least in the geographical area;
application of numerical models to relate the streams to the concentrations, in particular by simulating displacements of the gas during the investigation period of time, and by exploiting the measurements of the weather characteristics and other parameters comprising time; the numerical models comprising a direct model giving concentrations as a function of assessed streams and a reverse model giving streams as a function of measured or assessed concentrations;
the method comprising exclusions of some of the measurements of concentrations under conditions where the models are regarded as inaccurate, characterized in that the method comprises two assessments of concentrations by using the direct model and the reverse model, and in that the exclusions are decided for moments when a difference between both assessments is higher than a threshold.

8. The method according to claim 7, characterized in that the threshold is calculated as a function of assessed uncertainties or errors.

9. The method according to claim 8, characterized in that the assessed errors comprise assessed errors on a priori streams.

10. The method according to claim 8, characterized in that the assessed errors comprise assessed errors on observations.

11. The method according to claim 10, characterized in that the threshold is equal to ±(\sqrt{HBH^{T}+R_{dir}}), where B is the a priori error on the streams, R_{dir} the error of the direct model on the observations, and H and H^{T} are applications of the direct model.

12. The method according to claim 10, characterized in that the errors on the observations have a variable intensity, which is greater during nocturnal periods than diurnal periods.
